(19) United States
(12) Patent Application Publication
(10) Pub. No.: US 2025/0168716 A1
(43) Pub. Date: May 22, 2025

(54) METHOD AND SYSTEM FOR ARTIFICIAL INTELLIGENCE (AI)-BASED HANDOVER PROCEDURE

(71) Applicant: Samsung Electronics Co., Ltd., Gyeonggi-do (KR)

(72) Inventors: Liang HU, San Diego, CA (US); Yuan-Sheng CHENG, San Diego, CA (US); Philippe Jean Marc Michel SARTORI, Naperville, IL (US)

(21) Appl. No.: 18/956,933

(22) Filed: Nov. 22, 2024

Related U.S. Application Data
(60) Provisional application No. 63/601,919, filed on Nov. 22, 2023.

(51) Int. Cl. H04W 36/00; H04B 17/309; H04W 36/08

(52) U.S. Cl. CPC H04W 36/0058; H04B 17/309; H04W 36/08

(57) ABSTRACT

Methods and devices are provided in which a user equipment (UE) receives configuration information from a base station (BS). The configuration information includes an indication enabling artificial intelligence (AI)-based handover. The UE determines that an event triggers transmission of a measurement report based on UE measurements and AI inference by the UE. The UE transmits the measurement report to the BS, and performs the AI-based handover to a target BS. The AI-based handover is initiated based on the measurement report.

### CROSS-REFERENCE TO RELATED APPLICATION

This application claims the priority benefit under 35 U.S.C. § 119(e) of U.S. Provisional Application No. 63/601,919, filed on Nov. 22, 2023, the disclosure of which is incorporated by reference in its entirety as if fully set forth herein.

### TECHNICAL FIELD

The disclosure generally relates to wireless systems. More particularly, the subject matter disclosed herein relates to improvements to user equipment (UE) mobility using artificial intelligence (AI).

### SUMMARY

The application of AI and machine learning (ML) algorithms in communication networks may be utilized in network infrastructure and UE functionalities of 5^{th} Generation (5G)-advanced and 6^{th} Generation (6G) networks. AI may serve as a tool to facilitate faster and more informed decision-making for networks based on historical training data. The potential benefits of introducing AI/ML may include reducing feedback/control signaling overhead, providing more accurate feedback, and enhancing AI algorithms that require coordination between base stations (BSs) (e.g., gNode Bs (gNBs)) and UEs. These benefits, in turn, may lead to improved network and UE performance in terms of throughput and reliability.

A decision for a connected mode handover (i.e., determining whether a UE should initiate or perform a handover) may be made by a BS based on measurement reports provided by the UE. These reports may include various measurement items such as, for example, reference signal received power (RSRP) measurements, reference signal received quality (RSRQ) measurements, and signal-to-interference plus noise ratio (SINR) measurements, at the cell or beam level. The measurements may be collected periodically or triggered by specific events to assess the signal quality of the serving cell and neighboring cells. The network may always be in control of the process. However, the UE may have more information than the network, and may be better suited to decide the best moment to perform the handover.

In order to improve handover performance using AI/ML at the UE, a procedure may rely on UE-initiated handover while maintaining a high level of control by the network on the handover process. A network may allow the UE to report the signal quality (e.g., RSRP) of both a current (or serving) cell and a target cell, and set rules for handovers. However, this approach may become overly complex and may add significant overhead, as the network may require multiple consecutive measurement results instead of a small number of quality values.

To solve this problem, predefined measurement report mechanisms, or events, have been introduced for UEs. The specific type of event that a UE reports may be determined by a radio resource control (RRC) signaling message sent by the BS. A measurement report may be triggered when the measured value crosses a certain target value (either going higher or lower). This target value may be set using a threshold method, which is an absolute value, or an offset value method, which is a relative value in reference to, for example, a serving cell's value.

This rule-based mobility may perform well in normal mobility scenarios with acceptable complexity and overhead. However, one issue with the above approach is that it cannot achieve optimum performance in extreme scenarios such as, for example, 5G new radio (NR) frequency range 2 (FR2) and/or high mobility. Specifically, rule-based mobility is reactive by design, and the overall mobility procedure may not be fast enough to adapt to channel variations in extreme mobility scenarios. Additionally, it features high complexity, measurement effort, and signaling overhead for suboptimum mobility performance. Further, new capacity-hungry services (e.g. extended reality (XR)) may require a reliable mobility connection with high throughput and low latency.

To overcome these issues systems and methods are described herein to optimize the handover management procedures by introducing a new measurement event that triggers a UE measurement report based on a prediction by an AI model at the UE, and new assistance information for the handover decision at the BS. Also described is a new UE measurement report and other UE assistance information for a BS-side AI model.

The above approaches improve on previous methods by enabling the mobility procedure to achieve optimum performance in extreme mobility scenarios.

In an embodiment, a method is provided in which a UE receives configuration information from the BS. The configuration information includes an indication enabling AI-based handover. The UE determines that an event triggers transmission of a measurement report based on UE measurements and AI inference by the UE. The UE transmits the measurement report to the BS, and performs the AI-based handover to a target BS. The AI-based handover is initiated based on the measurement report.

In an embodiment, a UE is provided that includes a processor and a non-transitory computer readable storage medium storing instructions. When executed, the instructions cause the processor to receive configuration information from the BS. The configuration information includes an indication enabling AI-based handover. The instructions also cause the processor to determine that an event triggers transmission of a measurement report based on UE measurements and AI inference by the UE. The instructions further cause the processor to transmit the measurement report to the BS, and perform the AI-based handover to a target BS. The AI-based handover is initiated based on the measurement report.

In an embodiment, a wireless system is provided that includes a UE configured to receive configuration information from the BS. The configuration information includes an indication enabling AI-based handover. The UE is also configured to determine that an event triggers transmission of a measurement report based on UE measurements and AI inference by the UE. The UE is further configured to transmit the measurement report to the BS, and perform the AI-based handover to a target BS. The BS is configured to transmit the configuration information to the UE, receive the measurement report from the UE, determine a handover decision based on the measurement report, and transmit the handover decision to the UE to perform the AI-based handover.

### BRIEF DESCRIPTION OF THE DRAWING

In the following section, the aspects of the subject matter disclosed herein will be described with reference to exemplary embodiments illustrated in the figures, in which:

FIG. 1 is a diagram illustrating inter-BS handover in a wireless communication system, according to an embodiment;

FIG. 2 is a diagram illustrating a UE side AI-based handover procedure, according to an embodiment;

FIG. 3 is a flowchart illustrating a method for performing AI-based handover at the UE, according to an embodiment;

FIG. 4 is a diagram illustrating a BS side AI-based handover procedure, according to an embodiment;

FIG. 5 is a diagram illustrating a life cycle management framework for AI-based handover, according to an embodiment; and

FIG. 6 is a block diagram of an electronic device in a network environment, according to an embodiment.

### DETAILED DESCRIPTION

In the following detailed description, numerous specific details are set forth in order to provide a thorough understanding of the disclosure. It will be understood, however, by those skilled in the art that the disclosed aspects may be practiced without these specific details. In other instances, well-known methods, procedures, components and circuits have not been described in detail to not obscure the subject matter disclosed herein.

Reference throughout this specification to “one embodiment” or “an embodiment” means that a particular feature, structure, or characteristic described in connection with the embodiment may be included in at least one embodiment disclosed herein. Thus, the appearances of the phrases “in one embodiment” or “in an embodiment” or “according to one embodiment” (or other phrases having similar import) in various places throughout this specification may not necessarily all be referring to the same embodiment. Furthermore, the particular features, structures or characteristics may be combined in any suitable manner in one or more embodiments. In this regard, as used herein, the word “exemplary” means “serving as an example, instance, or illustration.” Any embodiment described herein as “exemplary” is not to be construed as necessarily preferred or advantageous over other embodiments. Additionally, the particular features, structures, or characteristics may be combined in any suitable manner in one or more embodiments. Also, depending on the context of discussion herein, a singular term may include the corresponding plural forms and a plural term may include the corresponding singular form. Similarly, a hyphenated term (e.g., “two-dimensional,” “pre-determined,” “pixel-specific,” etc.) may be occasionally interchangeably used with a corresponding non-hyphenated version (e.g., “two dimensional,” “predetermined,” “pixel specific,” etc.), and a capitalized entry (e.g., “Counter Clock,” “Row Select,” “PIXOUT,” etc.) may be interchangeably used with a corresponding non-capitalized version (e.g., “counter clock,” “row select,” “pixout,” etc.). Such occasional interchangeable uses shall not be considered inconsistent with each other.

Also, depending on the context of discussion herein, a singular term may include the corresponding plural forms and a plural term may include the corresponding singular form. It is further noted that various figures (including component diagrams) shown and discussed herein are for illustrative purpose only, and are not drawn to scale. For example, the dimensions of some of the elements may be exaggerated relative to other elements for clarity. Further, if considered appropriate, reference numerals have been repeated among the figures to indicate corresponding and/or analogous elements.

The terminology used herein is for the purpose of describing some example embodiments only and is not intended to be limiting of the claimed subject matter. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

It will be understood that when an element or layer is referred to as being on, “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numerals refer to like elements throughout. As used herein, the term “and/or” includes any and all combinations of one or more of the associated listed items.

The terms “first,” “second,” etc., as used herein, are used as labels for nouns that they precede, and do not imply any type of ordering (e.g., spatial, temporal, logical, etc.) unless explicitly defined as such. Furthermore, the same reference numerals may be used across two or more figures to refer to parts, components, blocks, circuits, units, or modules having the same or similar functionality. Such usage is, however, for simplicity of illustration and ease of discussion only; it does not imply that the construction or architectural details of such components or units are the same across all embodiments or such commonly-referenced parts/modules are the only way to implement some of the example embodiments disclosed herein.

Unless otherwise defined, all terms (including technical and scientific terms) used herein have the same meaning as commonly understood by one of ordinary skill in the art to which this subject matter belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

As used herein, the term “module” refers to any combination of software, firmware and/or hardware configured to provide the functionality described herein in connection with a module. For example, software may be embodied as a software package, code and/or instruction set or instructions, and the term “hardware,” as used in any implementation described herein, may include, for example, singly or in any combination, an assembly, hardwired circuitry, programmable circuitry, state machine circuitry, and/or firmware that stores instructions executed by programmable circuitry. The modules may, collectively or individually, be embodied as circuitry that forms part of a larger system, for example, but not limited to, an integrated circuit (IC), system on-a-chip (SoC), an assembly, and so forth.

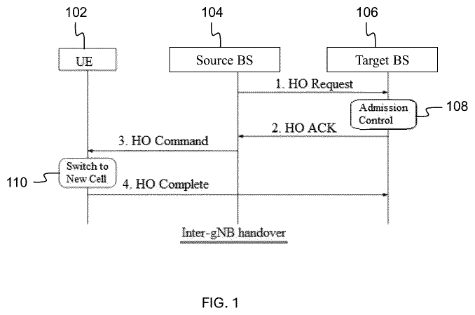

FIG. 1 is a diagram illustrating inter-BS handover in a communication system, according to an embodiment. Network controlled handover may be applied to 5G NR UEs in an RRC connected mode. Service may be provided to a UE 102 via a source BS 104, and handover may be performed between the source BS 104 and a target BS 106.

The source BS 104 may initiate handover and issue a handover request message (1) to the target BS 106. The target BS 106 may perform admission control 108 and provide an RRC configuration as part of a handover acknowledgement message (2) to the source BS 104. The source BS 104 may provide the RRC configuration to the UE 102 in a handover command message (3). The handover command message (3) may include at least a cell identifier (ID) and all information required to access the target cell so that the UE 102 can access the target cell without reading system information. The information required for contention based and contention free random access may be included in the handover command message (3). The access information to the target cell may include beam specific information, if necessary. The UE 102 moves the RRC connection to the target BS 106 and replies with a handover complete message (4) to the target BS 106.

Predefined events that may trigger the handover procedure of FIG. 1 may include, for example, when the quality of the source BS 104 surpasses a predefined threshold (A1), when the quality of the source BS 104 falls below a threshold (A2), when the target BS 106 becomes an offset better than the source BS 104 (A3), when the target BS 106 becomes better than a threshold (A4), when the source BS 104 worsens while the target BS 106 improves (A5), or when the target BS 106 becomes an offset better than the source BS 104 (A6). When such events occur, the UE 102 may trigger measurement reports that provide essential data for a handover decision at the source BS 104.

According to an embodiment, a new measurement event is provided in which a UE triggers a measurement report based on a prediction by an AI model (e.g., an inference) at a UE side of the system, while the handover determination is made by the BS. The prediction by the AI model may include a Boolean value of 1 or 0, which indicates whether or not the UE triggers the BS to perform a handover. If the value indicates that the UE triggers the BS to perform a handover, the prediction by the AI model at UE may also include a predicted target cell ID at a time T_i, where T_i is within a UE's prediction time window, a predicted average RSRP/RSRQ/SINR of the top K beams of a source cell at time T_i, and a predicted average RSRP/RSRQ/SINR of the top K beams per neighboring cells at time T_i. The UE may report the output to the BS as assistance information. The BS may then make the decision for handover in consideration of the UE's measurement report. The BS may not perform inference itself, but may provide AI/ML model updates to the UE, by collecting reports from other UEs in the cell.

According to another embodiment, handover may be based on a prediction by the AI model (e.g., inference) at the BS side of the system. The UE may provide UE side information to the BS for the inference decision in the form of a UE measurement report including UE assistance information. The UE side information may include the UE's location, the UE's trajectory, and RSRP/RSRQ/SINR measurements (source cell and neighboring cells). The UE may report the output to the BS as assistance information, which can be triggered by one of the above-described events or a new event. The BS may then perform inference and make a handover decision for the specific UE, considering the UE's assistance information.

New signaling methods and messages are also provided for data collection and model monitoring of AI-based handover, as part of life cycle management of the AI model.

As described above, a predefined set of mechanisms or events may be used for measurement reporting carried out by the UE. Each of these events may have specific criteria for initiation and termination. The criteria are based on mathematical inequalities, typically threshold-based, such as when the RSRP of a serving cell surpasses a predetermined threshold. To account for RSRP fluctuations, a hysteresis parameter may be introduced. When activated, the measurement report may only be triggered when the RSRP value fluctuates beyond the set hysteresis parameter.

With the advancements in AI/ML techniques, there is potential to go beyond predefined threshold-based triggering conditions. For example, a specific UE may use local data such as velocity, trajectory, location, RSRP of serving cells, and neighboring cells to train a local AI/ML model that can learn the optimal timing for handovers. When decisions regarding connected mode handovers are made by the BS based on local ML inferences, the UE may send measurement reports to the BS, suggesting a handover.

Accordingly, an intelligent AI/ML-assisted measurement reporting capability may be provided that introduces a new measurement report type.

The framework to support ML/AI techniques may involve federated model training at multiple UEs, with the model being updated at the BS side and the inference operation performed at the UE side. Alternatively, the framework may involve a general one-sided UE AI/ML model or a general one-sided network AI/ML model.

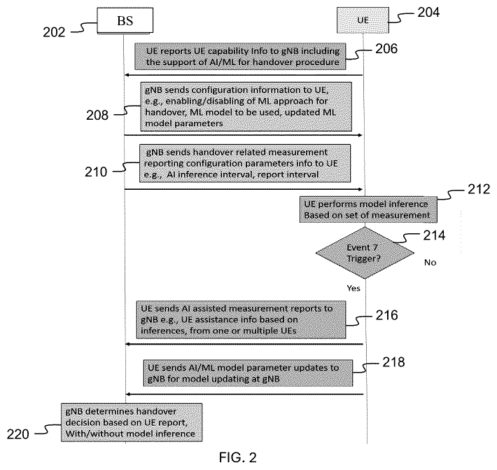

FIG. 2 is a diagram illustrating a UE side AI-based handover procedure, according to an embodiment. At 206, a UE 204 may report UE capability information to a BS 202 including the support of AI/ML for a handover procedure. Specifically, the UE capability information may include capability of data collection, capability of model training, capability of inference latency (e.g., timeline of predicted handover reporting), capability of monitoring, capability of models switching, and capability of model updating. This exchange may be performed during the RRC_CONNECTION establishment, at which the UE indicates the features it supports.

At 208, the BS 202 may send configuration information to the UE 204, including, for example, details about the AI/ML model used, AI/ML-related configuration information, enabling/disabling the ML approach for handover, trained model parameters, and/or whether the locally updated model parameters received from the UE 204 will be utilized. Model training may be performed at the BS side of the system. Alternatively, model training may be performed at another network entity and trained model parameters may be sent to the BS 202. Model training may be performed offline, and the trained model parameters may be sent to the BS 202 or a network entity. Configuration information may be broadcast as part of cell-specific information, such as, for example, a master information block (MIB), system information block 1 (SIB1), or other SIBs. Alternatively, all or part of the configuration information may be sent as UE-specific signaling or group-specific signaling using RRC signaling. The configuration information may be transmitted at the application layer, using extensible markup language (XML) or an equivalent markup language.

At 210, the BS 202 may send handover related measurement reporting configuration information (parameters) to the UE 204, including, for example, setting triggering conditions, inference intervals, and/or reporting intervals for the measurement reporting. The inference interval is the time period at which the UE may perform ML inference, defined within a reportConfigNR parameter. All or part of the measurement reporting configuration information may be sent to specific UEs using RRC messages, either once or at specific necessary times. Additional details about the signaling method are discussed in greater detail below.

At 212, the UE 204 may perform model inference based on a set of measurements and the configuration information received at 208 and 210. At 214, the UE 204 may determine whether an event triggers transmission of a measurement report message. If an event does not trigger transmission of a measurement report message, the UE 204 continues to perform model inference at 212.

If an event triggers transmission of a measurement report message, the UE 204 may send AI assisted measurement reports to the BS 202 at 216. The measurement report may include assistance information from the UE 204, suggesting potential neighboring cells for the handover operation. Triggering conditions for measurement reports and contents of the measurement report are described in greater detail below.

At 218, the UE 204 may send updated AI/ML model parameters to the BS 202 based on local training. Such updates may be received from one or multiple UEs. The UE 204 may perform model training based on local data available at the UE 204. The local data at the UE 204 may include information such as UE location, UE trajectory, and/or estimated downlink (DL) channel status. The BS 202 may determine whether updated model parameters sent from the UE 204 will be used. At 220, the BS 202 may determine a handover decision based on the received measurement reports. Such a determination may be performed with or without model inference.

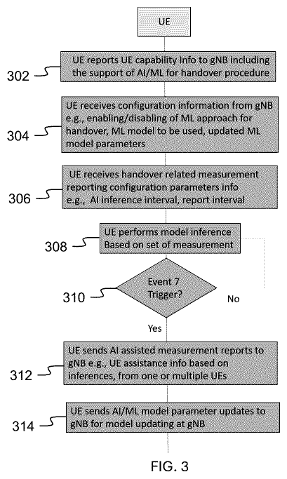

FIG. 3 is a flowchart illustrating a method for performing handover at the UE, according to an embodiment. At 302, a UE may report its AI/ML capabilities to support AI/ML-assisted handover management to a BS. For example, the UE capability may include capability of data collection, capability of model training, capability of inference latency (e.g., timeline of predicted handover reporting), capability of monitoring, capability of model switching, and capability of model updating.

At 304, the UE may receive configuration information from the BS. The configuration information may include details related to ML/AI techniques, such as, for example, enabling/disabling the ML approach for handover, the ML model to be used (model ID or specific AI/ML functionality), and/or trained model parameters. All or part of the configuration information may be broadcast as part of cell-specific information, such as by system information (e.g., master information block (MIB), system information block (SIB)-1, or other SIBs). Alternatively, all or part of the configuration information may be sent as UE-specific signaling or group-specific signaling.

At 306, the UE may receive handover related measurement reporting configuration parameter information from the BS, which may include the setting of triggering conditions, inference intervals, and reporting intervals for measurement reporting. All or part of the measurement reporting configuration information may be received through RRC messages, such as, for example, RRC reconfiguration, once or at any specific necessary time. The signaling method is described in greater detail below.

At 308, the UE may perform model inference based on the received configuration information, measurement reporting parameters, and local data. For example, the UE may follow the configured ML model, model parameters, and measurement reporting parameters, and may use local data and/or data sent from the BS to perform the inference operation,

At 310, based on the outcome of the inference, the UE may determine whether an event-based triggering condition is met. If the event-based triggering condition is not met, the UE may continue to perform model inference at 308. If the event-based triggering condition is met, the UE may send AI-assisted measurement reports to the BS at 312. The reports may include UE assistance information based on resulting inferences. At 314, the UE may send AI/ML model parameter updates to the BS for model updating at the BS.

All or some of the measurement report configuration information may be included in cell-specific data. For example, the information may be broadcasted as part of system information, or a new SIB may be introduced to convey this configuration information. For example, details such as enabling/disabling the ML approach, the choice of ML model, or model parameters for handover operations may be included in the broadcast. Updates to model parameters may also be included. Additionally, the configuration information for neighboring cells, such as the enabling/disabling of ML approaches, ML models, or model parameters for handover management in neighboring cells, may be indicated as part of system information, such as in MIB, SIB1, SIB3, SIB4, or other SIBs.

All or some of the measurement report configuration information may be conveyed through UE-specific signaling, such as UE-specific RRC signaling. Alternatively, the information may be sent through group-specific signaling. A UE group-specific radio network temporary identifier (RNTI) may be configured. The configuration of the group-specific RNTI may be performed through UE-specific RRC signaling.

An information element (IE) “ReportConfigNR” may specify the criteria for triggering an NR measurement reporting event based on cell measurement results, which can be derived from synchronization signal (SS)/physical broadcast channel (PBCH) block or channel state information (CSI)-reference signal (RS). The measurement reporting configuration parameters set by the BS for a UE may fall under “ReportConfigNR”, including “reportAmount”, “reportOnLeave”, “timeToTrigger”, “reportAddNeighMeas”, and “reportInterval”.

An additional field “Inference_Interval” may be introduced to “ReportConfigNR”, specifying the periodic time interval at which the UE can perform AI/ML inference. Possible values for this interval could be [10, 20, 30, 40, 60, 80, 100, 200] milliseconds (ms).

Additionally, an additional field “Top K beams/neighbor cells to predict at this interval” may be introduced to “ReportConfigNR”, specifying the Top K beams/neighbor cells with the highest measured RSRPs that UE needs to predict at a given future time instance.

Local data, including velocity, location, RSRP, RSRQ, SINR of serving cell and neighboring cells, may be used to perform AI inference in order to determine the event triggering, as set forth below:
1—Evaluate the measurement results of the serving cells Cs and neighboring cells Cn, and evaluate the velocity V, location L of the UE;
2—Perform AI/ML inference periodically as given by Inftnt, by taking Cs, Cn, V and L as input and generate output AI_out;
3—Evaluate the entering condition for this event to be satisfied when condition A7-1, as specified below, is fulfilled;
4—Evaluate the leaving condition for this event to be satisfied when condition A7-2, as specified below, is fulfilled.

### A7-1 (Entering Condition)

AI_out (t1)=1, i.e., output of AI/ML agent changes from 0 to 1

### A7-2 (Leaving Condition)

AI_out (t1)=0, i.e., output of AI/ML agent changes from 1 to 0

Cs is the measurement result of the serving cell. Cn is the measurement result of the neighboring cell. t₁ is an instance in time. Inflnt is the inference interval parameter for this event (i.e., inference_interval as defined within reportConfigNR for this event). Cs, Cn are expressed in dBm in case of RSRP, or in dB in case of RSRQ and RS-SINR. Infint expressed in ms. V is expressed in m/s. L is expressed in geolocation zone ID.

For UE AI/ML model input, measurement results of K (K≥1) latest measurement instances with the following options:
1—Only L1-RSRP measurement based on a set X of neighboring cells where a Y_i set of beams per neighboring cell i are measured;
2—Only L1-RSRP measurement based on a set X of neighboring cells where a Y_i set of beams per neighboring cell i are measured,+assistance information such as UE location, velocity and trajectory information; or
3—Only L1-RSRP measurement based on a set X of neighboring cells where a Y_i set of beams per neighboring cell i are measured,+neighboring cell ID and/or beam index to be measured.

For UE AV/ML model output, F predictions for F future time instances, where each prediction is for each time instance. At least F=1. For a given time instance t₁, if AI_out(t₁)=1, the prediction by the AI model at UE may also include:
1—Predicted target cell ID and/or associated beam index in the cell at t₁, optionally with a confidence/probability information;
2—Predicted L1 and/or L3 filtered average RSRP/RSRQ/SINR of the top K beams of source cell at t₁, where the top K beams at the source cell are the ones predicated to have the highest L1 measured/L3 filtered values in at t₁;
3—Predicted L1 and/or L3 filtered average RSRP/RSRQ/SINR of the top K beams per neighboring cells at time t₁, where the top K beams at each neighboring cell are the ones predicated to have the highest L1 measured and/or L3 filtered values in at t₁.

Alternatively, the prediction by the AI model at UE may also include:
1—Predicted target cell ID and/or associated beam index in the cell at t₁, optionally with a confidence/probability information;
2—Predicted L1 and/or L3 filtered average RSRP/RSRQ/SINR of the top K beams of source cell+the top K beam indexes at t₁, where the top K beams at the source cell are the ones predicated to have the highest L1 measured/L3 filtered values in at t₁;
3—Predicted L1 and/or L3 filtered average RSRP/RSRQ/SINR of the top K beams per neighboring cells+the top 1 beam indexes per neighbor cell at time t₁, where the top K beams at each neighboring cell are the ones predicated to have the highest L1 measured and/or L3 filtered values in at t₁.

ML model parameters reported by the UE to the BS may encompass updates of model parameters derived from local training at the UE side. These updates may be used for model refinement, particularly in federated learning approaches. The reporting of updated model parameters by the UE may depend on the configuration. For example, the UE may not report updates if they will not be utilized. Conversely, the UE may report updates if they will be utilized. The reporting of model parameters may occur through a physical uplink control channel (PUCCH) and/or a physical uplink shared channel (PUSCH). A new uplink control information (UCI) type, a new PUCCH format, and/or a new medium access control (MAC) control clement (CE) may be introduced to facilitate the reporting of model parameters.

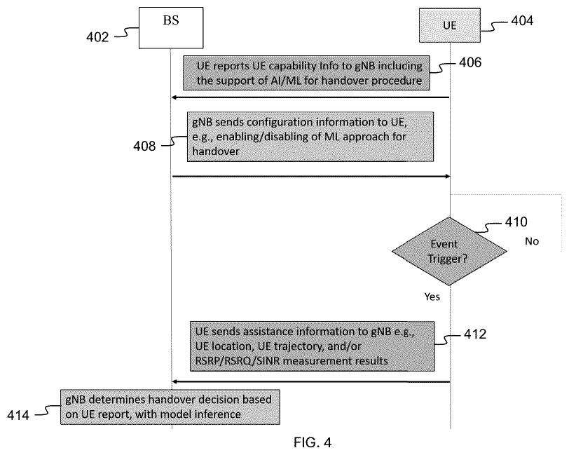

FIG. 4 is a diagram illustrating a BS side AI-based handover procedure, according to an embodiment. Specifically, FIG. 4 provides a high-level overview of BS and UE operations to support AI/ML techniques for handover, where inference is only performed at the BS.

At 406, a BS 402 receives information about the capabilities of a UE 404 from the UE 404. The information may include support for an AI/ML approach for a handover procedure.

At 408, the BS 402 may send configuration information to the UE 404. The configuration information may include the option to enable or disable the AI/ML approach for handover. All or part of this configuration information may be included in cell-specific data, such as in system information like MIB, SIB1, or other SIBs. Alternatively, all or some of the configuration information may be conveyed via UE-specific signaling or group-specific signaling.

At 410, the UE 404 may determine whether an event-based triggering condition is met. Reports may be triggered periodically, possibly through UE-RRC signaling. Semi-persistent or aperiodic triggering may be implemented. For example, DCI may trigger a report by introducing a new field (e.g., a 1-bit triggering field) to the DCI for report triggering. Alternatively, existing NR triggering events (e.g., events A1-A6, B1, B2) and the previously designed event A7 for handover measurement reports may be reused to trigger the UE assistance information report. In this case, an IE similar to the CSI report configuration IE may be introduced to configure the report format for UE assistance information, facilitating support for ML/AI techniques.

If an event-based triggering condition is met, the UE 404 may send assistance information to the BS 402. The assistance information may include UE location, UE velocity, UE trajectory, and/or RSRP/RSRQ/SINR measurement results.

Specifically, the assistance information may include the measured average RSRP/RSRQ/SINR of the top K beams of source cell and/or the top K beam indexes at t₁, where the top K beams at the source cell are the ones measured having the highest average measured values in the past X measurement instances.

The assistance information may include the predicted average RSRP/RSRQ/SINR of the top K beams per neighboring cells and/or the top i beam indexes per neighbor cell, where the top K beams at each neighboring cell are those measured having the highest average measured values in the past X measurement instances.

At 414, the BS 402 performs inference or receives the results of inference from a network entity, and using this inference, the BS 402 may determine whether a handover should be initiated for the UE 404, and if so, to which cell the UE should transition. Based on these inference results, the BS 402 may transmit control signals to the UE 404, dictating whether a handover should occur and specifying the target cell for the handover. The handover command may be conveyed through a PDCCH and/or a PDSCH. For example, a new downlink control information (DCI) format may be introduced to carry the handover command, with cyclic redundancy check (CRC) protection scrambled by a cell-RNTI (C-RNTI). Alternatively, a group-common DCI format can be used to indicate the handover command to a group of UEs located close to each other or with similar trajectories. This group-common DCI may adopt an existing DCI format (e.g., DCI format 2_2), or may introduce a new DCI format. A new group-specific RNTI may be defined for this purpose, and the BS may configure the UE with the group-specific RNTI through RRC signaling.

Upon receiving control signals from the BS 402, the UE 404 may execute the handover operation accordingly. The control signals may include commands based on the inference result. Consequently, the UE 404 may receive instructions from the BS 402 indicating whether a handover should take place and, if so, to which cell the handover should occur, and it follows these directives to perform the handover operation

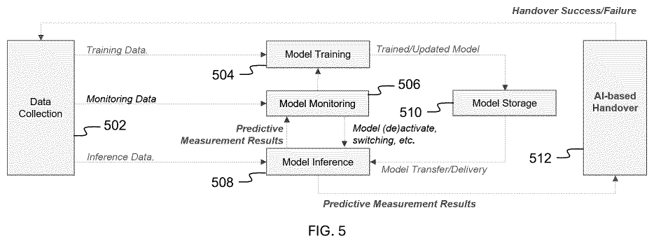

FIG. 5 is a diagram illustrating a life cycle management framework for AI-based handover, according to an embodiment. A data collection module 502 may provide training data to a model training module 504, monitoring data to a model monitoring module 506, and inference data to a model inference module 508. The model training module 504 may provide a trained/updated model to a model storage module 510. The model storage module 510 may transfer/deliver a module to the model inference module 508. The model monitoring module 506 may provide model activation and switching information to the model inference module 508. The model inference module may provide predictive measurement result to the model monitoring module 506 and to an AI-based handover module 512. The AI-based handover module 512 may provide handover success/failure information to the data collection module 502.

For benchmark/reference for the performance comparison, the model monitoring module 506 may use the best K beam(s)/cell ID(s) with highest RSRP/RSRQ/SINR actually measured at a future time t₁ and remain best for TTT duration, which are compared to the predicted ones at t₁, and/or actual measured RSRP/RSRQ/SINR values of best K beam(s)/cell ID(s) in the future time t₁.

Additionally, the handover successful/failure rate and/or the radio link failure rate may be to determine whether to perform model switch and/or fallback to a predetermined handover procedure.

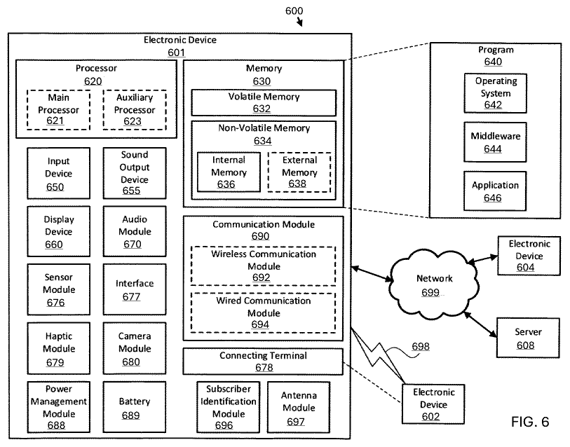

FIG. 6 is a block diagram of an electronic device in a network environment, according to an embodiment.

Referring to FIG. 6, an electronic device (or UE) 601 in a network environment 600 may communicate with an electronic device 602 via a first network 698 (e.g., a short-range wireless communication network), or an electronic device 604 or a server 608 via a second network 699 (e.g., a long-range wireless communication network). The electronic device 601 may communicate with the electronic device 604 via the server 608. The electronic device 601 may include a processor 620, a memory 630, an input device 650, a sound output device 655, a display device 660, an audio module 670, a sensor module 676, an interface 677, a haptic module 679, a camera module 680, a power management module 688, a battery 689, a communication module 690, a subscriber identification module (SIM) card 696, or an antenna module 697. In one embodiment, at least one (e.g., the display device 660 or the camera module 680) of the components may be omitted from the electronic device 601, or one or more other components may be added to the electronic device 601. Some of the components may be implemented as a single integrated circuit (IC). For example, the sensor module 676 (e.g., a fingerprint sensor, an iris sensor, or an illuminance sensor) may be embedded in the display device 660 (e.g., a display).

The processor 620 may execute software (e.g., a program 640) to control at least one other component (e.g., a hardware or a software component) of the electronic device 601 coupled with the processor 620 and may perform various data processing or computations.

As at least part of the data processing or computations, the processor 620 may load a command or data received from another component (e.g., the sensor module 676 or the communication module 690) in volatile memory 632, process the command or the data stored in the volatile memory 632, and store resulting data in non-volatile memory 634. The processor 620 may include a main processor 621 (e.g., a central processing unit (CPU) or an application processor (AP)), and an auxiliary processor 623 (e.g., a graphics processing unit (GPU), an image signal processor (ISP), a sensor hub processor, or a communication processor (CP)) that is operable independently from, or in conjunction with, the main processor 621. Additionally or alternatively, the auxiliary processor 623 may be adapted to consume less power than the main processor 621, or execute a particular function. The auxiliary processor 623 may be implemented as being separate from, or a part of, the main processor 621.

The auxiliary processor 623 may control at least some of the functions or states related to at least one component (e.g., the display device 660, the sensor module 676, or the communication module 690) among the components of the electronic device 601, instead of the main processor 621 while the main processor 621 is in an inactive (e.g., sleep) state, or together with the main processor 621 while the main processor 621 is in an active state (e.g., executing an application). The auxiliary processor 623 (e.g., an image signal processor or a communication processor) may be implemented as part of another component (e.g., the camera module 680 or the communication module 690) functionally related to the auxiliary processor 623.

The memory 630 may store various data used by at least one component (e.g., the processor 620 or the sensor module 676) of the electronic device 601. The various data may include, for example, software (e.g., the program 640) and input data or output data for a command related thereto. The memory 630 may include the volatile memory 632 or the non-volatile memory 634. Non-volatile memory 634 may include internal memory 636 and/or external memory 638.

The program 640 may be stored in the memory 630 as software, and may include, for example, an operating system (OS) 642, middleware 644, or an application 646.

The input device 650 may receive a command or data to be used by another component (e.g., the processor 620) of the electronic device 601, from the outside (e.g., a user) of the electronic device 601. The input device 650 may include, for example, a microphone, a mouse, or a keyboard.

The sound output device 655 may output sound signals to the outside of the electronic device 601. The sound output device 655 may include, for example, a speaker or a receiver. The speaker may be used for general purposes, such as playing multimedia or recording, and the receiver may be used for receiving an incoming call. The receiver may be implemented as being separate from, or a part of, the speaker.

The display device 660 may visually provide information to the outside (e.g., a user) of the electronic device 601. The display device 660 may include, for example, a display, a hologram device, or a projector and control circuitry to control a corresponding one of the display, hologram device, and projector. The display device 660 may include touch circuitry adapted to detect a touch, or sensor circuitry (e.g., a pressure sensor) adapted to measure the intensity of force incurred by the touch.

The audio module 670 may convert a sound into an electrical signal and vice versa. The audio module 670 may obtain the sound via the input device 650 or output the sound via the sound output device 655 or a headphone of an external electronic device 602 directly (e.g., wired) or wirelessly coupled with the electronic device 601.

The sensor module 676 may detect an operational state (e.g., power or temperature) of the electronic device 601 or an environmental state (e.g., a state of a user) external to the electronic device 601, and then generate an electrical signal or data value corresponding to the detected state. The sensor module 676 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 677 may support one or more specified protocols to be used for the electronic device 601 to be coupled with the external electronic device 602 directly (e.g., wired) or wirelessly. The interface 677 may include, for example, a high-definition multimedia interface (HDMI), a universal serial bus (USB) interface, a secure digital (SD) card interface, or an audio interface.

A connecting terminal 678 may include a connector via which the electronic device 601 may be physically connected with the external electronic device 602. The connecting terminal 678 may include, for example, an HDMI connector, a USB connector, an SD card connector, or an audio connector (e.g., a headphone connector).

The haptic module 679 may convert an electrical signal into a mechanical stimulus (e.g., a vibration or a movement) or an electrical stimulus which may be recognized by a user via tactile sensation or kinesthetic sensation. The haptic module 679 may include, for example, a motor, a piezoelectric element, or an electrical stimulator.

The camera module 680 may capture a still image or moving images. The camera module 680 may include one or more lenses, image sensors, image signal processors, or flashes. The power management module 688 may manage power supplied to the electronic device 601. The power management module 688 may be implemented as at least part of, for example, a power management integrated circuit (PMIC).

The battery 689 may supply power to at least one component of the electronic device 601. The battery 689 may include, for example, a primary cell which is not rechargeable, a secondary cell which is rechargeable, or a fuel cell.

The communication module 690 may support establishing a direct (e.g., wired) communication channel or a wireless communication channel between the electronic device 601 and the external electronic device (e.g., the electronic device 602, the electronic device 604, or the server 608) and performing communication via the established communication channel. The communication module 690 may include one or more communication processors that are operable independently from the processor 620 (e.g., the AP) and supports a direct (e.g., wired) communication or a wireless communication. The communication module 690 may include a wireless communication module 692 (e.g., a cellular communication module, a short-range wireless communication module, or a global navigation satellite system (GNSS) communication module) or a wired communication module 694 (e.g., a local area network (LAN) communication module or a power line communication (PLC) module). A corresponding one of these communication modules may communicate with the external electronic device via the first network 698 (e.g., a short-range communication network, such as BLUETOOTH™, wireless-fidelity (Wi-Fi) direct, or a standard of the Infrared Data Association (IrDA)) or the second network 699 (e.g., a long-range communication network, such as a cellular network, the Internet, or a computer network (e.g., LAN or wide area network (WAN)). These various types of communication modules may be implemented as a single component (e.g., a single IC), or may be implemented as multiple components (e.g., multiple ICs) that are separate from each other. The wireless communication module 692 may identify and authenticate the electronic device 601 in a communication network, such as the first network 698 or the second network 699, using subscriber information (e.g., international mobile subscriber identity (IMSI)) stored in the subscriber identification module 696.

The antenna module 697 may transmit or receive a signal or power to or from the outside (e.g., the external electronic device) of the electronic device 601. The antenna module 697 may include one or more antennas, and, therefrom, at least one antenna appropriate for a communication scheme used in the communication network, such as the first network 698 or the second network 699, may be selected, for example, by the communication module 690 (e.g., the wireless communication module 692). The signal or the power may then be transmitted or received between the communication module 690 and the external electronic device via the selected at least one antenna.

Commands or data may be transmitted or received between the electronic device 601 and the external electronic device 604 via the server 608 coupled with the second network 699. Each of the electronic devices 602 and 604 may be a device of a same type as, or a different type, from the electronic device 601. All or some of operations to be executed at the electronic device 601 may be executed at one or more of the external electronic devices 602, 604, or 608. For example, if the electronic device 601 should perform a function or a service automatically, or in response to a request from a user or another device, the electronic device 601, instead of, or in addition to, executing the function or the service, may request the one or more external electronic devices to perform at least part of the function or the service. The one or more external electronic devices receiving the request may perform the at least part of the function or the service requested, or an additional function or an additional service related to the request and transfer an outcome of the performing to the electronic device 601. The electronic device 601 may provide the outcome, with or without further processing of the outcome, as at least part of a reply to the request. To that end, a cloud computing, distributed computing, or client-server computing technology may be used, for example.

Embodiments of the subject matter and the operations described in this specification may be implemented in digital electronic circuitry, or in computer software, firmware, or hardware, including the structures disclosed in this specification and their structural equivalents, or in combinations of one or more of them. Embodiments of the subject matter described in this specification may be implemented as one or more computer programs, i.e., one or more modules of computer-program instructions, encoded on computer-storage medium for execution by, or to control the operation of data-processing apparatus. Alternatively or additionally, the program instructions can be encoded on an artificially-generated propagated signal, e.g., a machine-generated electrical, optical, or electromagnetic signal, which is generated to encode information for transmission to suitable receiver apparatus for execution by a data processing apparatus. A computer-storage medium can be, or be included in, a computer-readable storage device, a computer-readable storage substrate, a random or serial-access memory array or device, or a combination thereof. Moreover, while a computer-storage medium is not a propagated signal, a computer-storage medium may be a source or destination of computer-program instructions encoded in an artificially-generated propagated signal. The computer-storage medium can also be, or be included in, one or more separate physical components or media (e.g., multiple CDs, disks, or other storage devices). Additionally, the operations described in this specification may be implemented as operations performed by a data-processing apparatus on data stored on one or more computer-readable storage devices or received from other sources.

While this specification may contain many specific implementation details, the implementation details should not be construed as limitations on the scope of any claimed subject matter, but rather be construed as descriptions of features specific to particular embodiments. Certain features that are described in this specification in the context of separate embodiments may also be implemented in combination in a single embodiment. Conversely, various features that are described in the context of a single embodiment may also be implemented in multiple embodiments separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described herein. Other embodiments are within the scope of the following claims. In some cases, the actions set forth in the claims may be performed in a different order and still achieve desirable results. Additionally, the processes depicted in the accompanying figures do not necessarily require the particular order shown, or sequential order, to achieve desirable results. In certain implementations, multitasking and parallel processing may be advantageous.

As will be recognized by those skilled in the art, the innovative concepts described herein may be modified and varied over a wide range of applications. Accordingly, the scope of claimed subject matter should not be limited to any of the specific exemplary teachings discussed above, but is instead defined by the following claims.

What is claimed is:

1. A method comprising:
receiving, at a user equipment (UE), configuration information from a base station (BS), wherein the configuration information comprises an indication enabling artificial intelligence (AI)-based handover;
determining, by the UE, that an event triggers transmission of a measurement report based on UE measurements and AI inference by the UE;
transmitting, by the UE, the measurement report to the BS; and
performing, by the UE, the AI-based handover to a target BS, wherein the AI-based handover is initiated based on the measurement report.

2. The method of claim 1, further comprising:
transmitting, by the UE, capability information to the BS, wherein the capability information indicates whether the UE supports the AI-based handover.

3. The method of claim 1, wherein the configuration information further comprises an AI model and AI model parameters.

4. The method of claim 3, further comprising:
receiving, at the UE, measurement report parameters from the BS, wherein the measurement report parameters comprise at least one of an AI inference interval and a measurement report interval.

5. The method of claim 4, further comprising:
performing, by the UE, AI model inference based on the UE measurements.

6. The method of claim 5, wherein the measurements comprise one or more of a reference signal received power (RSRP) measurement, a reference signal received quality (RSRQ) measurement, and a signal to interference plus noise ratio (SINR) measurement.

7. The method of claim 5, wherein the measurement report comprises assistance information based on the AI model inference, wherein the assistance information comprises one or more of a predicted handover decision, BS beams having highest predicted RSRP or RSRQ values, and neighboring BSs having highest predicted RSRP or RSRQ values.

8. The method of claim 5, further comprising:
transmitting, by the UE, updates to the AI model parameters to the BS.

9. A user equipment (UE) of a wireless system, the UE comprising:
a processor; and
a non-transitory computer readable storage medium storing instructions that, when executed, cause the processor to:
receive configuration information from a base station (BS), wherein the configuration information comprises an indication enabling artificial intelligence (AI)-based handover;
determine that an event triggers transmission of a measurement report based on UE measurements and AI inference by the UE;
transmit the measurement report to the BS; and
perform the AI-based handover to a target BS, wherein the AI-based handover is initiated based on the measurement report.

10. The UE of claim 9, wherein the instructions further cause the processor to:
transmit capability information to the BS, wherein the capability information indicates whether the UE supports the AI-based handover.

11. The UE of claim 9, wherein the configuration information further comprises an AI model and AI model parameters.

12. The UE of claim 11, wherein the instructions further cause the processor to:
receiving measurement report parameters from the BS, wherein the measurement report parameters comprise at least one of an AI inference interval and a measurement report interval.

13. The UE of claim 12, wherein the instructions further cause the processor to:
perform AI model inference based on the UE measurements.

14. The UE of claim 13, wherein:
the measurements comprise one or more of a reference signal received power (RSRP) measurement, a reference signal received quality (RSRQ) measurement, and a signal to interference plus noise ratio (SINR) measurement.

15. The UE of claim 13, wherein the measurement report comprises assistance information based on the AI model inference, wherein the assistance information comprises one or more of a predicted handover decision, BS beams having highest predicted RSRP or RSRQ values, and neighboring BSs having highest predicted RSRP or RSRQ values.

16. The UE of claim 13, wherein the instructions further cause the processor to:
transmit updates to the AI model parameters to the BS.

17. A wireless system comprising:
a user equipment (UE) configured to:
receive configuration information from a base station (BS), wherein the configuration information comprises an indication enabling artificial intelligence (AI)-based handover;
determine that an event triggers transmission of a measurement report based on UE measurements and AI inference by the UE;
transmit the measurement report to the BS; and
perform the AI-based handover to a target BS; and
the BS configured to:
transmit the configuration information to the UE;
receive the measurement report from the UE;
determine a handover decision based on the measurement report; and
transmit the handover decision to the UE to perform the AI-based handover.

18. The wireless system of claim 17, wherein the UE is further configured to:
transmit capability information to the BS, wherein the capability information indicates whether the UE supports the AI-based handover.

19. The wireless system of claim 17, wherein the UE is further configured to:
receive measurement report parameters from the BS, wherein the measurement report parameters comprise at least one of an AI inference interval and a measurement report interval.

20. The wireless system of claim 19, wherein the UE is further configured to:
perform AI model inference based on the UE measurements.
